(19) United States
(12) Patent Application Publication
(10) Pub. No.: US 2008/0037080 A1
(43) Pub. Date: Feb. 14, 2008

(54) Illumination arrangement for an imager

(76) Inventors: Robert Spano, Smithtown, NY (US); David Tsi Shi, Stony Brook, NY (US); Frank Gong, Syosset, NY (US)

Correspondence Address: FAY KAPLUN & MARCIN, LLP, 15O BROADWAY, SUITE 702, NEW YORK, NY, 10038, US

(21) Appl. No.: 11/501,533

(22) Filed: Aug. 9, 2006

(51) Int. Cl. H04N 1/46

(52) U.S. Cl. 358/509

(57) ABSTRACT

Described is an illumination arrangement for an imager. A device comprises a scanning engine, a housing with the scanning engine residing inside the housing and an illumination arrangement coupled to the housing providing illumination for the scanning engine. The illumination has a direct line of sight to an object at which the scanning engine is directed.

### FIELD OF INVENTION

The present invention relates generally to illumination arrangements for imagers.

### BACKGROUND

Optical devices such as scanners and imagers are relied on for business and personal use in a wide variety of applications. As would be understood by those skilled in the art, it is recommended that the imagers use adequate illumination to generate an image. The quality of the image generated by an imager is affected by the amount of illumination.

### SUMMARY OF THE INVENTION

The present invention relates to an illumination arrangement for an imager. A device comprises a scanning engine, a housing with the scanning engine residing inside the housing and an illumination arrangement coupled to the housing providing illumination for the scanning engine. The illumination has a direct line of sight to an object at which the scanning engine is directed.

### BRIEF DESCRIPTION OF THE DRAWINGS

FIG. 1 shows a perspective view of an optical device including an illumination arrangement placed in the molding of the optical device according to an embodiment of the present invention.

FIG. 2 shows a view of a front side of the optical device of FIG. 1 with the illumination arrangement in the molding of the optical device according to the embodiment of the present invention.

FIG. 3 shows a cross sectional view of the front side of the optical device of FIG. 1 with the illumination arrangement in the molding of the optical device according to the embodiment of the present invention.

### DETAILED DESCRIPTION

The present invention may be further understood with reference to the following description and the appended drawings, wherein like elements are referred to with the same reference numerals. The exemplary embodiment of the present invention describes a system for an illumination arrangement for hand-held optical devices. The illumination feature is embedded in a mold of the scanner near the image scanning engine and outside a protective window according to the present invention. The use of the illumination arrangement along with its advantages will be discussed in detail below. The illumination feature will be described in regard to a hand-held arrangement for an image based scanning device. However, those skilled in the art will understand that this device is exemplary only and that the exemplary illumination arrangement may be applied to any device that requires illumination. It should be noted that the hand-held device may be mobile or stationary.

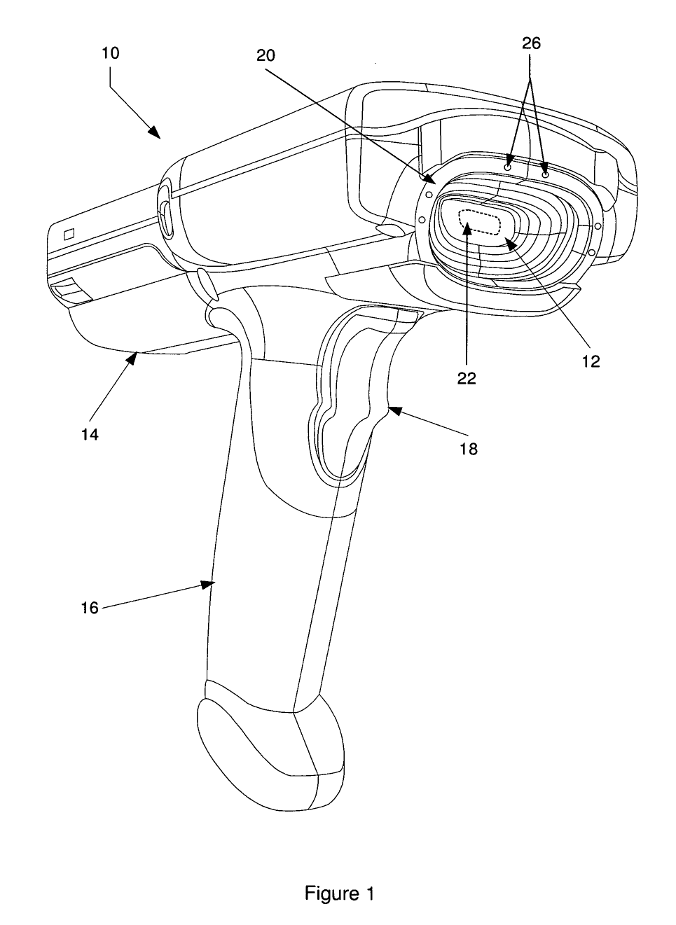

FIG. 1 shows an optical device 10 including an illumination arrangement 26 placed in the molding 20 of the optical device 10 according to an embodiment of the present invention. The optical device 10, which in this embodiment is an imager, includes a window 12 mounted in a housing 14 which includes, for example, a pistol grip 16, a scanning actuator 18, and a molding 20. A protective window 12 is held in the molding 20, which is a part of the housing 14. The protective window 12 is placed to provide a primary guard to a scanning engine 22. The scanning engine 22 for an imager may be, for example, a camera. The scanning engine 22 is often costly relative to the components of the mobile device. Furthermore, if the scanning engine 22 is damaged, the mobile device becomes useless. Scanning engines 22 for laser based scanners and image based scanners both operate by scanning an object. Therefore, a clear line of sight is necessary. In order to allow the scanning engine 22 to operate, the protective window 12 is composed of a transparent material. The protective window 12 is often made of a scratch-resistant glass or a durable plastic.

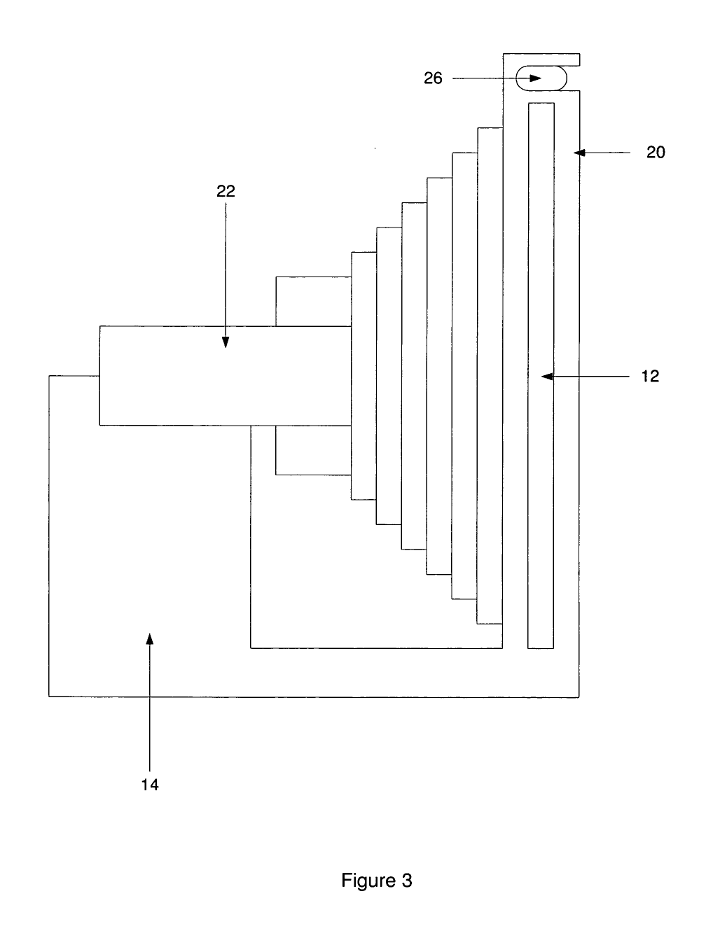

Referring to FIG. 3, the scanning engine 22 is mounted on the housing 14 along with supporting electronics, a battery, etc. It should again be noted that the scanning engine 22 for an imager may be, for example, a camera. As would be understood by those skilled in the art, the position of the scanning engine 22 relative to the window 12 is determined based on the properties of the scanning engine 22, the window 12 and the desired functionality of the device 10. Specifically, the optical properties of the window 12 and the scanning engine 22 dictating an optimal distance between a forward end of the scanning engine 22 (i.e., side that faces the window 12) and an inner face of the window 12 and, consequently, determining the size of a space within the housing forward of the forward end of the scanning engine 22.

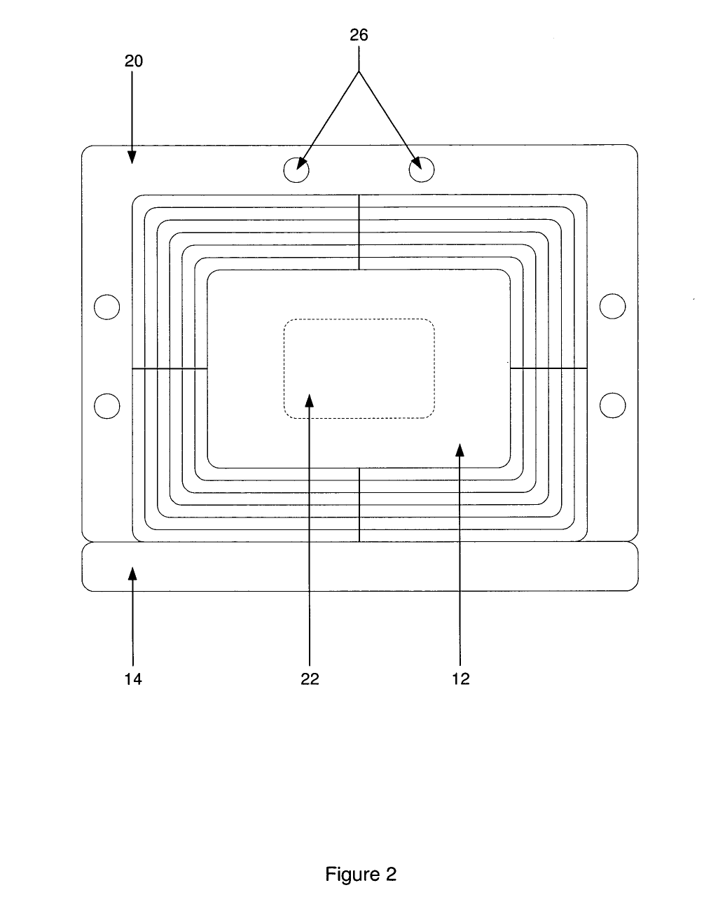

FIG. 2 shows a view of a front side of the optical device 10 with the illumination arrangement 26 in the molding 20 of the optical device 10 according to the embodiment of the present invention. According to the exemplary embodiment illustrated in FIG. 2, the illumination arrangement 26 is embedded in the molding 20 of the optical device 10. The illumination arrangement 26 may include one or more light emitting components (LECs). For example, the LECs may be light bulbs, LEDs, etc. Specifically, the molding 20 is manufactured to include the illumination arrangement 26. While the term embedded has been used to describe the illumination arrangement 26, this does not mean that the illumination arrangement 26 is necessarily inside or within the molding 20. The illumination arrangement 20 may be within the molding 20 or it may be external to the molding 20. The term embedded is used to indicate that the molding 20 may receive the illumination arrangement 26.

For example, in one embodiment, the molding 20 may be manufactured to include the necessary components for the illumination arrangement 26 such as connectors or appropriate holders for the LECS, electrical connections (e.g., wires, fuses) to connect the LECs to the power supply of the optical device 10. The LECs may be held below or flush with the outer surface of the molding 20 or may extend out from the outer surface of the molding 20.

In another embodiment, the illumination arrangement 26 may be a self contained component that is, for example, manufactured in the shape of the molding 20, but includes all the necessary components to provide illumination. The molding 20 may then include a connector to connect the illumination arrangement 26 to the molding 20. The connector may be both an electrical connector to provide power to the LECS and a mechanical connector to securely fasten the illumination arrangement 26 to the molding 20. In this embodiment, the illumination arrangement 26 may be releasably connected to the molding 20.

FIGS. 1 and 2 illustrate an exemplary embodiment where a predetermined number (e.g., 4-16) of LECs are embedded in the molding 20. It should be noted that the use of, for example, six LECs is exemplary only and that other illumination arrangements 26 exist. For example, the number of LECs may depend on the strength (e.g., wattage, lumens, etc.) per LEC. In another example, the number of LECs may depend on the purpose of the optical device 10, such as using the optical device 10 to cover a wide area for a scan that may require more LECs compared to covering a small area that may only require a few LECs. It should be noted that the above described use of LECs in the illumination arrangement 26 is exemplary only and that the configuration may depend on various other criteria that is subjective to a user.

FIG. 3 shows a cross sectional view of the front side of the optical device 10 with the illumination arrangement 26 in the molding 20 of the optical device 10 according to the embodiment of the present invention. According to the exemplary embodiment illustrated in FIG. 3, the illumination arrangement 26 is embedded in the molding 20 of the optical device 10. It should again be noted that the term embedded is used to indicate that the molding 20 may receive the illumination arrangement. FIG. 3 illustrates an exemplary embodiment where the light produced by the LECs do not pass through the window 12. As discussed above, the scanning engine 22 is located behind the window 12 in an optimal distance. That is, the scanning engine 22 is located internal to the window 12 and the illumination arrangement 26 is located external to the window 12.

A user may activate the illumination arrangement 26 through several ways. For example, the user may depress the scanning actuator 18. Using the scanning actuator 18 affords further options in terms of how the illumination arrangement 26 functions. For example, the scanning actuator 18 may be designed so that a processor (not shown) determines the amount that a user depresses the scanning actuator 18. The amount of depression determines the amount of illumination that a user desires. The amount of illumination (or illumination level) may be controlled by, for example, the amount of power provided to the LECs, turning on selected ones of the LECs, etc. Another example of activating the illumination arrangement 26 is the user may turn on a switch (not shown) that activates the illumination arrangement 26. The switch may simply be an on/off switch or it may be a dial. The dial may function similarly to the scanning actuator 18 in that the amount of illumination may be set by the user. In addition to a user personally activating the illumination arrangement 26, the optical device 10 may also activate the illumination arrangement automatically, for example, upon turning on the device or anticipating when the scanning engine 22 will be utilized.

The illumination arrangement 26 embedded in the molding 20 affords many advantages to the user. Specifically, there is no light attenuation nor internal reflection of the light associated with components of the optical device (e.g., the protective window 12). That is, the light from the LECs mounted in the molding 20 has a direct line of sight to the object to be scanned when the scanning window 12 is pointed at the object. In addition, the molding 20 offers a significant amount of space to mount the LECs, thereby allowing a large number of LECs if needed.

Furthermore, the replacement of the LECs may be done efficiently because the LECs are essentially external to the optical device 10. The seals of the optical device 10 (e.g., created by the protective window 12 and the molding 20/housing 14) need not be opened for LEC replacement. Thus, LECs may be replaced at the user location without any damage or breaking of factory seals for the optical device 10. In addition, because the user can replace or remove LECs as needed, the illumination pattern created by the illumination arrangement 26 is controllable by the user based on the removal or addition of LECs. For example, the producer of an optical device 10 may have different models with different scanning engines 22 (e.g., camera, laser scanner, etc.). However, the housing 14 may be similar for each of the models, e.g., the molding 20 may include the same number and locations for embeddable LECS. Depending on the type of scanning engine 22, the producer may insert LECs into the illumination arrangement 26 in a pattern that is optimal for the individual scanning engine 22. Furthermore, the user may have the ability to alter this pattern by removal or addition of LECs based on the environment in which the optical device 10 is being used.

It will be apparent to those skilled in the art that various modifications may be made in the present invention, without departing from the spirit or scope of the invention. Thus, it is intended that the present invention cover the modifications and variations of this invention provided they come within the scope of the appended claims and their equivalents.

What is claimed is:

1. A device, comprising:
a scanning engine;
a housing, the scanning engine residing inside the housing; and
an illumination arrangement coupled to the housing providing illumination for the scanning engine, the illumination having a direct line of sight to an object at which the scanning engine is directed.

2. The device according to claim 1, wherein the illumination arrangement is coupled to a molding of the housing.

3. The device according to claim 1, wherein the illumination arrangement is within the housing.

4. The device according to claim 1, wherein the illumination arrangement is removably coupled to the housing.

5. The device according to claim 1, wherein the illumination arrangement includes a plurality of light emitting components (LECs).

6. The device according to claim 5, wherein the light emitting components are one of light emitting diodes and light bulbs.

7. The device according to claim 1, further comprising:
a scanning actuator activating the illumination arrangement.

8. The device according to claim 1, the housing including a protective window, the scanning engine being located internal to the protective window and the illumination arrangement being located external to the protective window.

9. The device according to claim 5, wherein each of the LECs are removably connected to the illumination arrangement.

10. The device according to claim 1, further comprising:
a user operable switch mounted on the housing for activating the illumination arrangement.

11. The device according to claim 1, wherein an illumination level provided by the illumination arrangement is variable.

12. An illumination arrangement, comprising:
a plurality of light emitting components (LECs); and
a molding, the molding being part of a housing of an optical device, the plurality of light emitting components being embedded within the molding, and the molding being on a surface of the optical device providing the light emitting components a direct line of sight to an object.

13. The illumination arrangement of claim 1, wherein the optical device is an image based scanner.

14. The illumination arrangement of claim 1, wherein the light emitting components are one of light bulbs and light emitting diodes.

15. The illumination arrangement of claim 1, wherein the illumination arrangement is automatically activated upon activation of the optical device.

16. The illumination arrangement of claim 12, wherein an illumination level provided by the illumination arrangement is variable.

17. A device comprising:
a scanning engine;
a housing, the scanning engine residing inside the housing; and
an illumination means providing direct line of sight illumination for the scanning engine.

18. The device according to claim 17, wherein the illumination means includes a plurality of light emitting components.

19. The device according to claim 18, wherein each of the LECs is removably connected to the illumination means.

20. The device according to claim 17, wherein the illumination means is coupled to a molding of the housing.
